(19) United States
(12) Patent Application Publication
(10) Pub. No.: US 2012/0295040 A1
(43) Pub. Date: Nov. 22, 2012

(54) HARD COAT FILM, POLARIZING PLATE AND LIQUID CRYSTAL DISPLAY DEVICE

(75) Inventor: Ryota Kuki, Kobe-shi (JP)

(73) Assignee: KONICA MINOLTA ADVANCED LAYERS ,INC., Hachioji-shi ,Tokyo (JP)

(21) Appl. No.: 13/519,681

(22) PCT Filed: Dec. 22, 2010
(86) PCT No.: PCT/JP2010/073140

§ 371 Date: Jun. 28, 2012

(30) Foreign Application Priority Data
Jan. 8, 2010 (JP) 2010-002626

(51) Int. Cl. B32B 5/16; B32B 23/00

(52) U.S. Cl. 428/1.31; 428/327; 428/532; 428/522

(57) ABSTRACT

A hard coat film has wide width and uniform and excellent surface hardness and does not easily suffer from exfoliation or cracks when the hard coat film is cut. A polarizing plate uses the hard coat film, and is employed in a liquid crystal display device. The hard coat film is obtained by arranging a hard coat layer on a cellulose acylate film. The hard coat film is characterized in that the cellulose acylate film contains elastic particles and a cellulose acetate that has a degree of substitution of acyl groups of 2.0 or more but less than 2.5, and the maximum value of tan δ (loss modulus/storage modulus) of the cellulose acylate film is 0.80-2.00 (inclusive) with respect to the film temperature from 20° C. to 200° C.

### FIELD OF THE INVENTION

The present invention relates to a hard coat film, a polarizing plate and a liquid crystal display device, and, more in detail, relates to a hard coat film having a wider film width and a uniform and excellent surface hardness, while being suffered from only limited occurrence of exfoliation or cracks in the cutting process of the hard coat film, and a polarizing plate and a liquid crystal display device employing the hard coat film.

### BACKGROUND OF THE INVENTION

In recent years, a highly functional optical film provided with such as an antireflection function or an antistatic function has been required in accordance with full colorization of a notebook type personal computer and a cell phone, and higher precision requirement for a display. The surface of such a display is often touched by hand, whereby the display is required to be resistant to scratching. Accordingly, a hard coat film having a hard coat layer is usually provided on the surface of a display.

As a hard coat film, one having a wider film width has been desired in accordance with the requirement for a large size display device, while exhibiting a high physical strength such as the hardness of a hard coat layer (for example, refer to Patent Document 1).

On the other hand, in a hard coat film of a wider film width, there have been problems of lowered quality or a lowered yield ratio due to the occurrence of exfoliation or cracks in the cutting process of the hard coat film. It was found that such exfoliation or cracks in the cutting process of a hard coat film notably occurs specifically in a film which was subjected to stretching of a high stretching ratio to obtain a wider width film, and that the solution of such a problem is rather difficult. The technique disclosed in Patent Document 1 was made to overcome coating unevenness forming a line shaped defect or unevenness of reflected light of a wider width hard coat film by incorporating an ionic liquid in the film, however, a new technique has still been needed for the prevention of exfoliation or cracks in the cutting process of a hard coat film employing a stretched film in a high stretching ratio.

### PRIOR ART DOCUMENT

### Patent Document

Patent Document 1: Japanese Patent Application Publication Open to Public Inspection (hereafter referred to as JP-A) No. 2008-191544

### SUMMARY OF THE INVENTION

### Problems to be Solved by the Invention

Accordingly, an object of the present invention is to provide a hard coat film having a wider film width and a uniform and excellent surface hardness, while being suffered from only limited occurrence of exfoliation or cracks in the cutting process of the hard coat film, and a polarizing plate and a liquid crystal display device employing the hard coat film.

### Means to Solve the Problems

The aforementioned object of the present invention present invention is achieved by the following structures.

1. A hard coat film comprising a cellulose acylate film laminated thereon a hard coat layer, wherein

the cellulose acylate film comprises a cellulose acetate having an acyl substitution degree of 2.0 or more but less than 2.5, and elastic particles, and

a maximum value of tan δ at temperatures of 20° C. to 200° C. is 0.08 or more but 2.00 or less, tan δ being a value of “a loss modulus/a storage modulus”.

2. The hard coat film of Item 1, wherein

the elastic particles are crosslinked acrylic resin particles having an average particle diameter of 0.01 μm to 1.0 μm.

3. The hard coat film of Item 1 or 2, wherein

the cellulose acylate film comprises at least a sugar ester compound or an ester compound having a structure represented by Formula (I),

P1-(G2-T1)n-G3-P2 (I)

wherein P1 and P2 each independently represent a monocarboxylic acid residue, G2 and G3 each independently represent a glycol residue having two or more carbon atoms, T1 represents a carboxylic acid residue, n represents an integer of 1 or more, wherein

G2 and T1 each may contain a plurality of residues.

4. A polarizing plate comprising a polarizer adhered with a hard coat film of any one of Items 1 to 3 on at least one surface of the polarizer.
5. A liquid crystal display device employing the polarizing plate of Item 4.

### Effect of the Invention

According to the present invention, a hard coat film having a wider film width and a uniform and excellent surface hardness, while being suffered from only limited occurrence of exfoliation or cracks in the cutting process of the hard coat film, and a polarizing plate and a liquid crystal display device employing the hard coat film can be obtained.

### EMBODIMENTS TO CARRY OUT THE INVENTION

Embodiments to carry out the present invention will be explained in detail below, however, the present invention is not limited thereto.

According to an intensive examination by the present inventor with respect to the aforementioned problems, the present invention was achieved as a solving method of the finding that the occurrence of exfoliation or cracks in the cutting process, specifically, of a hard coat film having a wider film width depends on the viscoelasticity of the film in a stretching process of the film. In the present invention, it was also found that, by employing a hard coat film having the constitution of the present invention, it is possible to manufacture a hard coat film in which the stretching property of a transparent resin film necessary for obtaining a wider width film is improved while a uniform and excellent surface hardness is provided.

Namely, according to claim 1, exfoliation or cracks in the cutting process can be improved by a hard coat film comprising a cellulose acylate film laminated thereon a hard coat layer, wherein the cellulose acylate film comprises a cellulose acetate having an acyl substitution degree of 2.0 or more but less than 2.5, and elastic particles, and a maximum value of tan δ at temperatures of 20° C. to 200° C. is 0.08 or more but 2.00 or less, tan δ being a value of “a loss modulus/a storage modulus”, which is a larger tan δ value when compared with the conventional tan δ values.

The mechanism of action will be described below.

The value of tan δ is a parameter relating to the viscoelasticity of a film in the stretching process. In the present invention, the problem of exfoliation or cracks in the cutting process of the film is improved by adjusting the maximum value of tan δ (namely, loss modulus/storage modulus) at a film temperature in the range of 20° C. to 200° C. to 0.80 or more but 2.00 or less, which is lager the conventional value. Such maximum value of tan δ (namely, loss modulus/storage modulus) has become possible to attain by using a cellulose acetate having a prescribed acyl substitution degree and by incorporating particles of an elastic material. The value of tan δ can be more easily controlled by an appropriate combination of the kind and amount of the above particles of an elastic material, and, further, the kind and amount of an additive, for example, a plasticizer having a specific structure. As the results of intensive studies, the inventor has found that, when the value of tan δ is 0.80 or lower, the viscoelasticity of the film becomes too low to make the stretched film hard and brittle. As the results, exfoliation or cracks in the cutting process of the film tends to occur. Alternatively, when the value of tan δ is 2.00 or more, the viscoelasticity of the film becomes too high, whereby unevenness in the elasticity of the film or in the thickness tends to occur. As the results, it was found that the uniformity in the hardness of the hard coat film tends to be lost. Thus, it was found that the effect of the present invention can be obtained by controlling the value of tan δ.

Claim 2 is characterized in that the elastic particles are crosslinked acrylic resin particles having an average particle diameter of 0.01 μm to 1.0 μm, and claim 3 is characterized in that the cellulose acylate film comprises at least a sugar ester compound or an ester compound having a structure represented by Formula (I), both of which relate to methods to control the above mentioned tan δ value. According to these structures, a hard coat film being suffered from only limited occurrence of exfoliation or cracks in the cutting process of the hard coat film, and being excellent in stretching aptitude and hardness can be produced.

The present invention will be explained in more detail below.

<tan δ>

The tan δ value is a value also called a loss tangent and defined by tan δ=G′/G″ (wherein G′: a storage modulus, G″: a loss modulus). The storage modulus (G′) and loss modulus (G″) are obtained by measuring a transparent film with a dynamic viscoelasticity meter DVA-225 (manufactured by IT Keisoku Seigyo K.K.). The storage modulus (G′) and loss modulus (G″), respectively, mean the real component having a coordinate phase with the strain, in which the energy of strain is stored as stress, and the imaginary component having a phase advanced by 90° from the strain γ, in which loss occurs, for example, by transducing the energy of strain into other energy, in the complex modulus caused when sine wave strain (deformation) is applied by vibrating a specimen. In the present invention, the tan δ value is a value at a measuring frequency of 1 Hz. The method of measuring dynamic viscoelasticity is not specifically limited, however, the dynamic viscoelasticity is preferably measured in the machine direction or in the direction perpendicular to the machine direction. The term “machine direction” as used in the present invention means the same direction as the film casting direction when the transparent film is produced by a solvent casting method which will be described later, and, in this case, the machine direction coincides with the longitudinal direction of the transparent film.

The maximum value of tan δ as used herein means a highest tan δ value on a tan δ-temperature (° C.) absorption curve (temperature range: from 20 to 200° C.). The maximum value of tan δ can be made to fall in the range of 0.80 or more but 2.00 or less by appropriately controlling the conditions of the film manufacturing process. The maximum value of tan δ is specifically preferably 0.90 or more but 1.90 or less.

When the tan δ value of a cellulose acylate film is within the above described range, occurrence of exfoliation and cracks is reduced, and a wide width hard coat film exhibiting uniform and superior surface hardness can be obtained.

As one of the measuring methods of the tan δ value, the sample is subjected to a moisture control in advance under a condition of 23° C. and 55% RH for 24 hours, and the measurement is conducted while increasing the temperature under the following condition or at a set temperature.

| | |
|---|---|
| Measuring apparatus: | Dynamic viscoelasticity meter DVA-225 |
| | (manufactured by IT Keisoku Seigyo K.K.) |
| Sample: | Width: 5 mm, length: 50 mm |
| | (gap is set at 20 mm) |
| Measuring condition: | Stretching mode |
| Set temperature | 20 to 200° C. |
| Heating condition | 5° C./min |
| Frequency | 1 Hz |

### <Cellulose Acylate Film>

The substrate film used for the hard coat film according to the present invention is a cellulose acylate film containing cellulose acetate of which acyl substitution degree is 2.0 or more but less than 2.5. The acyl substitution degree is more preferably 2.2 to 2.45.

The cellulose acetate can be used alone or in combination of cellulose acetates having different substitution degrees. The substitution degree of the acyl group can be determined according to the method of ASTM-D817-96.

With respect to the cellulose acetate, the number average molecular weight (Mn) is preferably 125000 or more but less than 155000, the weight average molecular weight (Mw) is preferably 265000 or more but less than 310000, and Mw/Mn is preferably 1.9 to 2.1.

The number average molecular weight (Mn) and the molecular weight distribution (Mw) can be measured by use of high speed liquid chromatography. The measurement condition is as follows.

Solvent: methylene chloride

Column: Shodex K806, K805, K803G (3 columns manufactured by Showa Denko K. K. were utilized in connection.)

Column temperature: 25° C.

Sample concentration: 0.1 weight %

Detector: RI Model 504 (manufactured by GL Sciences Inc.)

Pump: L6000 (manufactured by Hitachi, Ltd.)

Flow rate: 1.0 ml/min

Calibration curve: A calibration curve by 13 samples of standard polystyrene STK (manufactured by Toso Co. Ltd.) having Mw=1,000,000-500 was utilized. 13 samples were utilized in an approximately equal interval.

The cellulose acetate according to the present invention can be synthesized by a method known in the art.

Cellulose as raw materials of cellulose acetate is not specifically limited, and includes such as cotton linter, wood pulp (obtained from acicular trees or from broad leaf trees) and kenaf. Further, cellulose acetates prepared from them can be utilized by mixing each of them at an arbitrary ratio. Cellulose acetate, in the case that an acylation agent is acid anhydride (such as acetic anhydride, propionic anhydride, and butyric anhydride), is prepared by a reaction utilizing a proton type catalyst such as sulfuric acid in an organic acid such as acetic acid or in an organic solvent such as methylene chloride.

In the case that an acylation agent is an acid chloride (CH₃COCl, C₂H₅COCl or C₃H₇COCl), the reaction is performed utilizing a basic compound such as amine as a catalyst. Specifically, the synthesis can be performed referring to a method described in JP-A No. 10-45804.

### (Elastic Particles)

The elastic particles according to the present invention are polymer particles having a core-shell structure, and preferably particles having rubber-like polymer particles (namely, a core portion) each having a hard peripheral such as methyl methacrylate. Specifically, the methacylate is preferably particles having an average particle diameter of from 0.01 μm to 1.0 μm. It is known that the elastic particles are usually formed via a seed emulsion polymerization method. As such manufacturing methods, those disclosed in JP-A No. 7-70255 and in WO 2005/012425 are may be used.

The core portion of the elastic particle is a rubber-like polymer particle, and it is preferably constitute of an alkyl acrylate rubber. As an alkyl acrylate monomer, an alkyl acrylate monomer of which alkyl group has 2 to 8 carbon atoms, or such an alkyl acrylate monomer and a monomer which is copolymerizable with the alkyl acrylate monomer are preferably used. In this case, it is preferable that a crosslinkable monomer and/or a grafted monomer are used.

Examples of an alkyl acrylate of which alkyl group has 2 to 8 carbon atoms include ethyl acrylate, propyl acrylate, butyl acrylate, cyclohexyl acrylate and 2-ethylhexyl acrylate. Of these, butyl acrylate is preferably used. Examples of a monomer polymerizable with an alkyl acrylate include: aromatic vinyl compounds and aromatic vinylidene compounds such as styrene, vinyltoluene and α-methyl styrene; vinyl cyanides and vinylidene cyanides such as acrylonitrile and methacrylonitrile; and alkyl methacrylates such as methyl methacrylate and butyl methacrylate. Examples of a crosslinkable monomer include: aromatic divinyl monomers such as divinyl benzene; and alkane polyol polyacrylates and alkane polyol polymethacrylates such as ethylene glycol diacrylate, ethylene glycol dimethacrylate, butylene glycol diacrylate, hexane diol diacrylate, hexane diol dimethacrylate, oligoethylene glycol diacrylate, oligoethylene glycol dimethacrylate, trimethylol propane diacrylate, trimethylol propane dimethacrylate, trimethylol propane triacrylate, and trimethylol propane trimethacrylate. Of these, butylene glycol diacrylate and hexane diol diacrylate are used preferably.

Examples of a grafted monomer include unsaturated carboxylic acid allyl esters such as an allyl acrylate, allyl methacrylate, diallyl malete, diallyl fumarate and diallyl itaconate. Of these, allyl methacrylate is used preferably. Each of such a crosslinkable monomer and a grafted monomer is used in the range of 0.05 to 2% by mass, and preferably in the range of 0.1 to 1% by mass based on the total mass of monomers used for the core latex. The obtained core polymer is a rubber like polymer which preferably has a glass transition temperature of −30° C. or lower. When the glass transition temperature exceeds −30° C., the craze occurs in the stretching process tends not be improved. The mass ratio of core latex is preferably in the range of 40 to 70% by mass, based on the total mass of core-shell polymers.

The polymerization of the methyl methacrylate glass-like shell portion, which subsequently conducted, is carried out by emulsion polymerizing a methyl methacrylate monomer under existence of the core latex. As a methyl methacrylate monomer, methyl methacrylate monomer or such methyl methacrylate and a monomer which is copolymerizable with the methyl methacrylate monomer are preferably used.

As a monomer which is copolymerizable with methyl methacrylate monomer vinyl polymerizable monomers may be cited, of which examples include alkyl acrylates such as ethyl acrylate and butyl acrylate; alkyl methacrylates such as ethyl methacrylate and butyl methacrylate; aromatic vinyls and aromatic vinylidenes such as styrene and α-methyl styrene; and vinyl cyanides and vinylidene cyanides such as acrylonitrile and methacrylonitrile. Of these, ethyl acrylate, styrene or acrylonitrile is preferably used. Also in the polymerization of the shell portion, a small amount of a crosslinkable monomer may be used as a copolymerizable monomer in addition to the above mentioned monomers, if necessary. There may be a case in which a core-shell polymer provided with higher shock resistance in a thermosetting resin can be obtained in this way. The same crosslinkable monomers used in the polymerization of the core portion may be used in this case. The amount of such a crosslinkable monomer is usually in the range of 0.01 to 2% by mass, and preferably in the range of 0.1 to 1% by mass, based on the total mass of monomers used for the polymerization of the shell portion. The polymer of the shell portion is a glass like polymer having a glass transition temperature of 60° C. or more. When the glass transition temperature of the polymer is less than 60° C., the aggregation of particles becomes prominent, whereby the dispersibilty tends to be degraded. It is preferable that the shell portion is crosslinked using a crosslinking agent, for example, ethylene glycol di(meth)acrylate, diethylene glycol di(meth)acrylate, triethylene glycol di(meth)acrylate or 1,3-butylene glycol di(meth)acrylate, in view of obtaining a superior solvent resistant property.

As a method to confirm that the particle has a core-shell structure, the size of core particle and the size particle after polymerization are compared, and, when the size of the polymerized particle is larger than the size of the core particle, the core-shell structure is confirmed to be formed. The particle having a crosslinked structure in the shell portion can be confirmed by confirming that solvent resistance is provided to the polymerized particle, when the solvent resistance of the core particle and the solvent resistance of the polymerized particle are compared. Also, the confirmation of the core-shell structure can be conducted by embedding particles in a resin, preparing a section and observing with an electron microscope to confirm the structure. In this case, the shell portion or the core portion may be colored for easy understanding.

The average particle diameter of the elastic particles according to the present invention is preferably in the range of 0.01 to 1.0 μm. When the average particle diameter is smaller than 0.01 μm, sufficient stretching property cannot be exhibited, and when the average particle diameter is larger than 1.0 μm, the haze of the film becomes a problem due to light scattering by the particles, resulting in lowering the contrast of a liquid crystal display device. Accordingly, it is necessary that the average particle diameter is within the above mentioned range to obtain the effect of the present invention.

The average particle diameter can be determined, for example, by observing the particle diameters of arbitrarily selected 100 particles using an electron microscope. The particle diameter of each particle as mentioned herein is expressed as the diameter of an assumed circle having the same area as the projected area of the particle. Alternatively, the average particle diameter can also be determined by diluting the particles in a solvent and by using a dynamic light scattering type particle diameter measuring apparatus ZETASIZER 1000HS (produced by Malvern Instruments Ltd).

It is preferable that the average particle diameter of the elastic particles is adjusted, for example, by growing the particles while adjusting the number of cycles of seed polymerization, by obtaining the polymer via a soap-free polymerization, by adjusting the amount of an emulsifier, by using an emulsifier having a weak emulsifying power or a protective colloid, or by adjusting the amount of a solvent when a seed particle dispersion liquid is obtained in a medium containing water as a main component.

The refractive index of the elastic particles is preferably closer to the refractive index of the transparent film to be used as a substrate to suppress the increase of haze. The refractive index of the elastic particles is preferably from 1.46 to 1.50, and more preferably from 1.47 to 1.49, since the refractive index of a cellulose ester film is around 1.47 to 1.49.

The elastic modulus of the elastic particles cannot be determined by a commonly known method due to the particle-like shape, however, as a compendium method, the elastic modulus of the elastic particles can be determined by measuring the compressive deformation rate against load of a dry pellet of the particles using a thermal mechanical analyzer, which will be described below. The elastic particles as mentioned in the present invention are particles of which the compressive deformation rate is preferably from 0.5 to 20%, more preferably from 1 to 10%, and most preferably from 1 to 2%.

### (Compressive Deformation Rate)

Using a thermal mechanical analyzer (commercial name TMA-10, produced by SEIKO Instruments, inc.), compressive deformation in height (mm), when 30 g of load is applied on a cylindrical sample having an area of 24 mm² and a height of 2 mm, is measured, and the compressive deformation rate is obtained according to the following equation.

For dispersion of elastic particles, common dispersers are usable. For example, a sand mill or a high pressure homogenizer is preferably used. A sand mill, containing beads with a size of 0.3-3 mmφ and a mill base, disperses particles by causing collision and shearing employing a centrifugal force of beads produced by rotating the disc at 300-3000 rpm. Examples of the beads include glass beads, zirconia beads, alumina beads, and steel beads. In the invention, zirconia beads having less contamination or glass beads in which contamination is not problem is preferred. In the sand mill, there are various types of a longitudinal, lateral or annular type. In the invention, a lateral or annular type sand mill is especially preferred in providing a more uniform shearing force. The disc, shaft or inside of the disperser inside tends to be ground off to produce contaminations. Therefore, it is preferred that the disc, shaft or inside of the disperser are preferably coated with ceramics or Teflon® to minimize the contaminations.

Examples of the sand mill include DAINO MILL (produced by W. A. Bachofen Co., Ltd.), NEW MYMILL (produced by Mitsui Kozan Co., Ltd.), SC MILL (produced by Mitsui Kozan Co., Ltd.), and NANO GRAIN MILL (produced by Asada Tekko Co., Ltd.).

The high pressure homogenizer is a medialess disperser which carries out dispersion employing shearing force or collision impact produced by passing a mill base at high speed through narrow tubes or orifices or by bombarding itself. For example, mill bases are allowed to collide with each other or to pass through narrow tubes or orifices having a diameter of from 50 to 2,000 μm at a high pressure of 10 to 300 MPa.

Examples of the high pressure homogenizer include MICRO FLUIDIZER (produced by Mizuho Kogyo Co., Ltd.), ULTIMIZER (produced by Sugino Machine Co., Ltd.), NANOMIZER (produced by Yoshida Kogyo Co., Ltd.), and CLEAR MIX and CLEAR MIX W MOTION (each produced by M Technique Co., Ltd.).

Dispersers such as an ultrasonic disperser, a ball mill, a high speed disper, an atriter, a three roll mill, Henschel Mixer, and a kneader are also usable.

As a method to add the particles, preferable is to directly add a dispersion liquid of the particles into a forming composition of a cellulose acylate film in view of generating less foreign substance. Also, it is possible to add the particles into a liquid containing a small amount of the resin and thereafter the liquid is added to the forming composition of a cellulose acylate film.

The amount of added elastic particles is in the range of 0.1 to 50% by mass, and preferably in the range of 0.1 to 10% by mass, based on the mass of the aforementioned cellulose acetate.

### <Sugar Ester Compounds>

The cellulose acylate film relating to the present invention preferably includes an ester compound which includes 1 to 12 of at least one kind of a furanose structure or a pyranose structure and in which all or a part of OH groups in its structure is esterified (also referred to as a sugar ester compound).

Such examples include: glucose, galactose, mannose, fructose, xylose, arabinose, lactose, sucrose, cellobiose, maltose, cellotriose, maltotriose and raffinose. Specifically preferable is one having both the furanose structure and the pyranose. As such an example, sucrose may be cite,

A monocarboxylic acid to be used in the present invention is not specifically limited, and known aliphatic monocarboxylic acids, alicyclic monocarboxylic acids and aromatic monocarboxylic acids may be used. These monocarboxylic acids may be used singly or in combination of two or more kinds.

Examples of a preferable aliphatic monocarboxylic acid include a saturated fatty acid such as acetic acid, propionic acid, butyric acid, isobutyric acid, valerianic acid, capronic acid, enanthic acid, caprylic acid, pelargonic acid, capric acid, 2-ethyl-hexanecarboxylic acid, undecylic acid, lauric acid, tridecylic acid, myristic acid, pentadecylic acid, palmitic acid, heptadecylic acid, stearic acid, nonadecanic acid, arachidic acid, behenic acid, lignoceric acid, cerotic acid, heptacosanoic acid, montanic acid and melissic acid, and a unsaturated fatty acid such as undecylic acid, oleic acid, sorbic acid, linolic acid, linolenic acid, arachidonic acid and octenic acid.

Examples of preferable alicyclic monocarboxylic acid, include cyclopentane carboxylic acid, cyclohexane carboxylic acid, cyclo octane carboxylic acid, and derivatives thereof.

Examples of preferable aromatic monocarboxylic acid include: benzoic acid, an aromatic monocarboxylic acid formed by introducing one to five alkyl or alkoxy groups into the benzene ring of benzoic acid such as acetic acid and toluic acid; an aromatic monocarboxylic acid having two or more benzene rings such as cinnamic acid, benzilic acid, biphenyl carboxylic acid, naphthalene carboxylic acid and tetralin carboxylic acid; and derivatives thereof. Among them, benzoic acid is particularly preferable.

Detailed production methods of these compounds have been disclosed in JP-A No. 62-42996 and JP-A No. 10-237084.

### <Additives>

In order to enhance the effect of the present invention, it is preferable to incorporate a compound represented by above mentioned Formula (I) as an additive. The compound represented by Formula (I) is a compound which contains aromatic monocarboxylic acid residues on both terminals of the molecule, and repeat units each containing: a glycol having 2 to 5 carbon atoms; and terephthalic acid or naphthalene dicarboxylic acid.

P1 and P2 in the above mentioned Formula (I) each independently are an aromatic monocarboxylic acid residue, and more preferably a benzoic acid. When an ester compound represented by Formula (I) in which P1 and P2 in Formula (I) each are an above mentioned residue is used, an excellent anti-moisture permeation property and a high Rt value can be provided to the cellulose ester resin, and the compatibility between the ester compound and the cellulose ester resin can be further improved.

G2 and G3 in the above mentioned Formula (I) each independently are preferably a glycol residue at least one selected from the group of a 1,2-propylene glycol residue, a 2-methylpropane diol residue and neopentyl glycol residue. When a compound represented by Formula (I) in which G2 and G3 in Formula (I) each are an above mentioned residue is used, the anti-moisture permeation property and the compatibility between the ester compound and the cellulose ester resin can be further improved.

In Formula (I), n may be any integer as far as it is 1 or more, however, n is preferably an integer in the range of 1 to 15.

The compound represented by Formula (I) preferably has a number average molecular weight in the range of 400 to 1500, more preferably has a number average molecular weight in the range of 400 to 1300, and still more preferably has a number average molecular weight in the range of 400 to 1000. The above mentioned number average molecular weight is a value determined by using gel permeation gel permeation chromatography (GPC) using tetrahydrofuran (THF) as an eluate and with polystyrene conversion.

It is preferable that the compound represented by Formula (I) has an acid value of 0.5 mgKOH/g or less. When the compound has an acid value within the above range, an excellent anti-moisture permeation property is provided to the film, and the modifier agent itself is stable.

The compound represented by Formula (I) can be produce, for example, by preparing a polyester having hydroxyl groups at both the terminals of the molecule by reacting a glycol and terephthalic acid or naphthalene dicarboxylic acid, followed by reacting the product with an aromatic monocarboxylic acid.

Examples of the above mentioned glycol include ethylene glycol, 1,2-propylene glycol, 1,3-propanediol, 2-methyl-1,3-propanediol, 1,2-butanediol, 1,3-butanediol, 1,4-butanediol, 2,3-butanediol, 1,5-pentanediol, neopentyl glycol, 1,2-cyclopentanediol, 1,3-cyclopentanediol and 1,4-cyclohexanediol, each of which may be used alone or in combination of two kind or more. Of these, 1,2-propylene glycol, 2-methyl-1,3-propanediol and neopentyl glycol are preferably used. Specifically, it is preferable to use 1,2-propylene glycol in view of obtaining a modifier for a cellulose ester resin, which enables to provide an excellent anti-bleeding property even under a high temperature and high humidity condition, and an excellent anti-moisture permeation property to a cellulose ester film.

Examples of a terephthalic acid or a naphthalene dicarboxylic acid which can be used for the production of a compound represented by Formula (I) include terephthalic acid, 1,4-naphthalene dicarboxylic acid, 2,3-naphthalene dicarboxylic acid, 2,6-naphthalene dicarboxylic acid, 2,7-naphthalene dicarboxylic acid, 1,8-naphthalene dicarboxylic acid, ester compounds and acid chlorides thereof; and an acid anhydride of 1,8-naphthalene dicarboxylic acid, each of which may be used alone or in combination of two kinds or more. Of these, it is preferable to use at least one selected from the group of terephthalic acid and dimethyl terephthalate in view of providing an excellent anti-moisture permeation property to a cellulose acylate film.

Examples of an aromatic monocarboxylic acid which can be used for the production of a compound represented by Formula (I) include benzoic acid, dimethyl benzoic acid, trimethyl benzoic acid, tetramethyl benzoic acid, ethylbenzoic acid, propylbenzoic acid, butylbenzoic acid, cumin acid, para-tertiarybutyl benzoic acid, ortho-toluic acid, meta-toluic acid, para-toluic acid, ethoxy benzoic acid, propoxy benzoic acid, naphthoic acid, nicotinic acid, furoic acid, anisic acid, and methyl esters and acid chlorides thereof; each of which may be used alone or in combination of two kinds or more. Of these, it is preferable to use benzoic acid in view of providing an excellent anti-moisture permeation property to a cellulose acylate film.

The compound represented by Formula (I) may be produce by conducting an esterification reaction using above mentioned glycol, terephthalic acid and/or naphthalene dicarboxylic acid and/or esterified compound thereof, and aromatic monocarboxylic acid, if necessary, under existence of an esterification catalyst at a temperature, for example, in the range of 180 to 250° C., for 10 to 25 hours employing a well known common method.

The compound represented by Formula (I) is preferably contained in the ration of 1 to 40% by mass, more preferably contained in the ratio of 5 to 35% by mass, and most preferably contained in the ratio of 5 to 20% by mass, based on the mass of above mentioned cellulose acetate.

### <Other Additives>

In order to improve the flowability or flexibility of the composite, other additive may be used in combination in a cellulose acylate film. Examples of a plasticizer include a aliphatic acid ester plasticizer, a trimellitic acid ester plasticizer, a phosphoric acid ester plasticizer, and an epoxy plasticizer.

It is preferable that the cellulose acylate film contains a UV absorbing agent. For example, cited may be triazoles such as 2-(5-methyl-2-hydroxyphenyl)benzotriazole, 2-[2-hydroxy-3,5-bis (α,α-dimethylbenzyl)phenyl]-2H-benzotriazole, and 2-(3,5-di-t-butyl-2-hydroxyphenyl)benzotriazole, as well as benzophenones such as 2-hydroxy-4-methoxybenzophenone, 2-hydroxy-4-octoxybenzophenone, or 2,2′-dihydroxy-4-methoxybenzophenone. Of UV absorbers, those having a molecular weight of at least 400 exhibit a high boiling point and are neither easily volatized nor scattered during molding at high temperature. Consequently, it is possible to effectively improve weather resistance via their addition of a relatively small amount.

Examples of UV absorbers having a molecular weight of at least 400 include benzotriazole type ones such as 2-[2-hydroxy-3,5-bis(α,α-dimethylbenzyl)phenyl]-2-benzotriazole, and 2,2-methylenebis[4-(1,1,3,3-tetrabutyl)-6-(2H-benzotriazole-2-yl)phenol; hindered amine type ones such as bis(2,2,6,6-tetramethyl-4-piperidyl)sebacate and bis(1,2,2,6,6-pentamethyl-4-piperidyl)sebacate; further hybrid type ones having hindered phenol and hindered amine structures in the molecule such as 2-(3,5-di-t-butyl-4-hydroxybenzyl)-2-n-butylmalonic acid bis(1,2,2,6,6-pentamethyl-4-piperidyl) or 1-[2-[3-(3,5-di-t-butyl-4-hydroxyphenyl)propionyloxy]ethyl-4-[3-(3,5-di-t-butyl-4-hydroxyphenyl)propionyloxy]-2,2,6,6-tetramethylpyperidine. These may be employed individually or in combinations of at least two types. Of these, particularly preferred are 2-[2-hydroxy-3,5-bis(α,α-dimethylbenzyl)phenyl]-2-benzotriazole and 2,2-methylenebis[4(1,1,3,3-tetrabutyl)-6-(2H-benzotriazole-2-yl)phenol.

Further, in order to minimize thermal decomposition and thermal staining during molding, it is possible to add various antioxidants to the cellulose acylate film. Still further, by the addition of antistatic agents, it is possible to provide the cellulose acylate film with antistatic capability.

The fire resistant acryl type resin composition containing phosphor type fire retardant may be used in the cellulose acylate film.

As phosphor type fire retardants employed here, listed may be mixtures incorporating at least one selected from red phosphorous, triaryl phosphoric acid esters, diaryl phosphoric acid esters, monoaryl phosphoric acid esters, aryl phosphoric acid compounds, aryl phosphine oxide compounds, condensed aryl phosphoric acid esters, halogenated alkyl phosphoric acid esters, halogen-containing condensed phosphoric acid esters, halogen-containing condensed phosphoric acid esters, and halogen containing phosphorous acid esters.

Specific examples thereof include triphenyl phosphate, 9,10-dihydro-9-oxa-10-phosphaphenantholene-10-oxide, phenylphosphonic acid, tris(β-chloroethyl)phosphate, tris(dichloropropyl)phosphate, and tris(tribromoneopentyl)phosphate.

In the present invention, a conventional matting agent containing particles may be incorporated in the cellulose acylate film with in the range in which the effect of the present invention is not disturbed. Examples of a matting agent containing particles include inorganic particles such as silicon dioxide, titanium dioxide, aluminum oxide, zirconium oxide, calcium carbonate, kaolin, talc, calcined calcium silicate, hydrated calcium silicate, aluminum silicate, magnesium silicate and calcium phosphate, and crosslinked polymer particles.

The cellulose acylate film is preferably a film which does not cause ductile fracture. In the present invention, ductile fracture, which is caused when a stress stronger than the strength of a material is applied to the material, is defined as fracture accompanied by marked elongation or contraction of the material until reaching final rupture. The fracture surface characteristically forms thereon a number of dents, called dimples.

Therefore, the film causing no ductile fracture has a feature that even when applying large stress to the film so as to bend the film double, no fracture is observed.

Liquid crystal display devices have continually increased in size, as well as the luminance of backlight sources. In addition, still higher luminance is demanded for outdoor use such as digital signage. Consequently, it is demanded that such cellulose acylate film is durable at a higher temperature. When the tension softening point is 105 to 145° C., it is judged that the film exhibits sufficient heat resistance, and it is specifically preferable to control it between 110 and 130° C.

As the specific method to determine the temperature which exhibits the tension softening point, for example, a TENSILON tester (RTC-1225A, produced by Orientec Co., Ltd.) may be employed, in which, an optical film is cut into 120 mm (longitudinal)×10 mm (width). The resulting film is tensioned at 10 N while elevating the temperature at a rate of 30° C. per minute. The temperature at which the tension decreased to 9 N is measured three times and the tension softening point is obtained by averaging the obtained temperatures.

Further, in view of heat resistance, a glass transition temperature (Tg) of a cellulose acylate film is preferably at least 110° C., is more preferably at least 120° C., but is most preferably at least 150° C.

“Glass transition temperature”, as described herein, refers to the midpoint glass transition temperature (Tmg) determined in accordance with JIS K 7121 (1987) in which measurements are carried out at a temperature elevating rate of 20° C./minute employing a differential scanning colorimeter (DSC-Type 7, produced by Perkin Elmer Co.).

Further, when the cellulose acylate film is used as a protective film for a polarizing plate of a liquid crystal display device, dimensional change due to moisture absorbing generates unevenness or change in retardation value which induces problem of low contrast or color unevenness. Particularly the above described problems are marked in case of the polarizing plate protective film of the liquid crystal display device used outdoor. Therefore, the ratio of dimensional change (%) is preferably less than 0.5%, and more preferably less than 0.3%.

Further, the number of defects at a diameter of at least 5 μm on the surface of the cellulose acylate film of the present invention is preferably 1 per 10 cm square or less, is more preferably 0.5 per 10 cm square or less, and is further preferably 0.1 per 10 cm square or less.

“Diameter of the defect”, as described herein, refers to the diameter when the defect is circular. When the defect is not circular, the area of the defect is determined via the following method while observed via a microscope, and the resulting maximum diameter (being a diameter of the inscribed circle) is taken.

The area of the defect, when it is an air bubble or foreign matter, is the size of the shadow when the defect is observed via a differential interference microscope. When the defect is a surface state change such as transfer of roller flaws or abrasion, the size is determined via observation employing the deferential interference microscope.

In the case of observation via reflected light, when the area of a defect is not clear, aluminum or platinum is vapor-deposited onto the surface, followed by further observation.

In order to manufacture high quality films with the least frequency of the above defects under desired productivity, it is effective that a polymer solution is precisely filtered prior to casting, the degree of cleanness around a caster is enhanced, and drying conditions after extrusion are set stepwise so that drying is efficiently carried out while minimizing foam formation.

When the number of defects is at least 1 in 10 cm square, productivity is occasionally degraded in such a manner that in the course of treatment during a post-process, when tension is applied to the film, the film breaks at the position of defects. Further, when the diameter of defects is at least 5 μm, they may be visually detected via observation of polarizing plates, and when employed as an optical material, bright spots are occasionally formed.

Further, even in the case in which nothing is detected via visual observation, when a hard coat layer is formed on the aforesaid film, defects (non-coated spots) are occasionally formed in such a manner that it is impossible to achieve uniform formation of coating materials. Defects, as described herein, refer to voids (being foam defects) in the film, generated by abrupt evaporation of solvents during the drying process of solution film production, and foreign matter (foreign matter defects) in the film due to foreign matter in a primary film making solution or mixed foreign matter during film production.

Further, rupture elongation of the cellulose acylate film of the present invention in at least one direction is preferably at least 10%, but is more preferably 20%, which is determined type on JIS-K7127-1999.

The upper limit of rupture elongation is not particularly limited, and the practical limit is approximately 250%. In order to increase the rupture elongation factor, it is effective to retard the formation of defects in film due to foreign matter and foaming.

Thickness of the cellulose acylate film of the present invention is preferably at least 20 μm, but is more preferably at least 30 μm. The upper limit of the thickness is also not particularly limited. When a film is prepared via a solution film producing method, in view of coatability, foaming, and solvent drying, the upper limit is approximately 250 μm. The film thickness may be appropriately selected according to the type on use.

Total light transmittance of the acrylic resin containing film of the present invention is preferably at least 90%, but is more preferably at least 93%. Further, the practical upper limit is approximately 99%. In order to achieve excellent transparency, represented by the above total light transmittance, it is effective that additives and copolymerizing components which absorb visible light are not allowed to be incorporated, and diffusion and absorption of light in the interior of the film is decreased by removing foreign matter in polymers via precise filtration.

Further, it is effective that roughness of the film surface is decreased by decreasing the surface roughness of film contacting portions (such as cooling rollers, calendering rollers, drums, belts, coating devices of a solution film production, or conveying rollers) during film production and diffusion and reflection of light on the film surface are decreased by reducing the refractive index of acrylic resins.

The refractive index of the cellulose ester film is preferably 1.30 to 1.70, and more preferably 1.40 to 1.65. The refractive index may be measured according to the method of JIS K7142 using an Abbe refractive index meter (produced by Atago Co., Ltd.)

### <Formation of Cellulose Acetate Film>

The method of formation of cellulose acylate film will be described, however, the present invention is not limited thereto.

As a cellulose acylate film production method applicable is an inflation method, a T-die method, a calendering method, a cutting method, a casting method, an emulsion method, or a hot press method.

Either a solution casting film formation method or a melt casting film formation method may be use to form a cellulose acylate film according to the present invention. As the characteristic of these methods, a melt casting film formation method is preferably used in view of avoiding a residual solvent used for dissolving the cellulose acetate, and a solution casting film formation method is preferably used in view of avoiding coloring of the film, avoiding defects due to foreign materials, or avoiding optical defects such as die lines.

Further, in the present invention, a method to heat a film forming material and to extrude on a drum or an endless belt to form a film, after the film forming material shows fluidity by being heated, is also included in the melt casting film formation method.

### (Organic Solvents)

When the cellulose acylate film of the present invention is produced via a solution casting method, as useful organic solvents to form a dope, any solvent may be employed without limitation as long as it simultaneously dissolves acrylic resin, cellulose ester resin, and other additives.

Examples thereof may include, chlorine type organic solvents, such as methylene chloride, and non-chlorine type organic solvents such as methyl acetate, ethyl acetate, amyl acetate, acetone, tetrahydrofuran, 1,3-dioxolane, 1,4-dioxane, cyclohexanone, ethyl formate, 2,2,2-trifluoroethanol, 2,2,3,3-hexafluoro-1-propanol, 1,3-difluoro-2-propanol, 1,1,1,3,3,-hexafluoro-2-methyl-2-propanol, 1,1,1,3,3,3-hexafluoro-2-propanol, 2,2,3,3,3-pentafluoro-1-propanol and nitroethane. Methylene chloride, methyl acetate, ethyl acetate and acetone are preferably employable.

It is preferable that other than the above organic solvents, incorporated in the dope, are aliphatic alcohols having a straight or branched chain having 1 to 4 carbon atoms in an amount of 1 to 40% by mass. As the alcohol ratio in the dope increases, the resulting web is gelled, whereby peeling from a metal support become easier. Further, as the ratio of alcohol is low, it enhances dissolution of cellulose acetate in non-chlorine type organic solvents.

Specifically, a dope composition is preferred which is prepared by dissolving, in solvents incorporating methylene chloride and aliphatic alcohols having a straight or branched chain having 1 to 4 carbon atoms, cellulose acetate, elastic particles, and other additive in an total amount of 15 to 45% by mass.

As aliphatic alcohols having a straight or branched chain having 1 to 4 carbon atoms, listed may be methanol ethanol, n-propanol, iso-propanol, n-butanol, sec-butanol, and tert-butanol. Ethanol is preferable among these in view of stability of the dope, relatively low boiling point and good drying performance.

A cellulose acylate film may be manufactured via a solution casting method. The solution casting method is carried out according to the following processes, namely, a process to dissolve a resin and additives in a solvent to prepare a dope, a process to cast the dope on a belt form or a drum form metal support, a process to dry the cast dope to make a web, a process to peel off the web from the metal support, a process to stretch the web or to hold the width, a process to further dry the web, and a process to wind up the finished film.

The concentration of cellulose acetater in a dope is preferably the higher with respect to decreasing a drying load after the dope has been east on a metal support, while filtering precision will be deteriorated due to an increased load at the time of filtering when the concentration of cellulose acetate is excessively high. The concentration to balance these is preferably 10-35% by mass and more preferably 15-25% by mass.

The metal support in the casting process is preferably those the surface of which is minor finished, and a stainless steel belt or a drum made of castings, the surface of which is plating finished, is preferably utilized.

The cast width can be set to 1-4 m. The surface temperature of a metal support in a cast process is from −50° C. to lower than a boiling point of a solvent not to cause foaming. It is preferable the temperature is the higher since a drying speed of a web can be set faster; however, excessively high temperature may sometimes cause foaming of a web or deterioration of flatness.

The support temperature is appropriately selected within the range of 0-100° C. and more preferably 5-30° C. It is also a preferable method to make a web gelled by cooling and to peel off the web from a drum with a plenty of residual solvent contained.

The method to control the temperature of a metal support is not specifically limited; however, there are a method to blow a hot wind or a cold wind on the web and a method to make hot water in contact with the rear side of a metal plate. A method to utilize hot water is preferable because time required to make a metal support become a constant temperature is short due to more efficient heat conduction.

In the case of employing a hot wind, a wind of a temperature higher than the aimed temperature with prevention of foaming may be employed, while employing a hot wind of a temperature higher than a boiling point of a solvent, in consideration of temperature down of a web due to heat of evaporation of a solvent.

In particular, it is preferable to efficiently perform drying by varying the temperature of the support and the temperature of drying wind, from casting to peeling.

To provide a good flatness of the cellulose acylate film, the residual solvent amount at the time of peeling a web from a metal support is preferably 10-150% by mass, more preferably 20-40% by mass or 60-130% by mass, and specifically preferably 20-30% by mass or 70-120% by mass.

In the present invention, a residual solvent amount is defined by the following equation.

Residual solvent amount (% by mass)={(M−N)/N}×100

Herein, M is a mass of a sample picked at an arbitrary time during or after manufacturing of a web or film and N is a mass after heating M at 115° C. for 1 hour.

Further, in a drying process of the cellulose acylate film, a web is preferably peeled from a metal support and further dried to make a residual solvent amount of not more than 1% by mass, more preferably not more than 0.1% by mass and specifically preferably 0-0.01% by mass.

In a film drying process, a roll drying method (in which a web is dried while being alternately passed through many rolls which are arranged up and down) or a method to dry a web while being transported by a tenter method may be applied.

### (Stretching Process)

The cellulose acylate film according to the present invention is preferably stretched in a high stretching ratio in order to obtain a wide width film.

In the stretching process, the film can be stretched in the longitudinal direction (also referred to as the MD direction) and in the width direction (also referred to as the TD direction) sequentially or simultaneously. The stretching ratios in the biaxial directions which bisect each other at right angles at the final stage of the stretching are preferably from 100% to 200% in the MD direction and from 110% to 200% in the TD direction, and further preferably from 100% to 150% in the MD direction and from 120% to 200% in the TD direction. Examples of the stretching method include: a method to provide a difference in the peripheral speed between a plurality of rollers and to conduct stretching in the MD direction between the rollers using the difference in the peripheral speed between the rollers; a method to fix the both edges of a web by clips or pins, and to stretch the web in the MD direction by expanding the distance between the clips or pins in the moving direction of the web; and a method to stretch a web in the TD direction by expanding the distance between the clips or pins, in the same way as described above, in the TD direction, or to stretch the web in both the MD/TD directions by simultaneously expanding the distances in the MD/TD directions.

In the film forming process, these width keeping or stretching in the TD direction is preferably conducted using a tenter. The tenter may be a clip tenter or a pin tenter.

Although the film conveying tension in the film forming process such as a tenter process depends on the temperature, the conveying tension is preferably from 120 N/m to 200 N/m, more preferably from 140 N/m to 200 N/m, and most preferably from 140 N/m to 160 N/m.

In the stretching process, the temperature is from (Tg−30) to (Tg+100)° C., preferably from (Tg−20) to (Tg+80)° C., and more preferably from (Tg−5) to (Tg+20)° C., provided that the glass transition temperature is expressed as Tg.

It is possible to control the Tg of a cellulose acylate film depending on the type and ratio of film constituting materials. In the usage of the present invention, Tg is preferably at least 110° C., and is more preferably at least 120° C.

Accordingly, the glass transition temperature is preferably at most 190° C., and is more preferably at most 170° C. During this operation, the Tg of the film is determined based on the method described in JIS K 7121.

The stretching temperature may be arbitrarily determined, however, it is preferable that the stretching temperature is 150° C. or more in relation to the glass transition temperature.

The width of the cellulose acylate film is not specifically limited, however, according to the purpose of the present invention, it is preferably from 1.5 m to 4 m, preferably from 1.7 m to 3.5 m, and specifically preferably from 2 m to 3 m, in view of improving the productivity of large screen liquid crystal display devices.

### (Melt Casting Method)

The cellulose acylate film may be formed via a melt casting method. The melt casting method refers to a method in which a composition containing a resin and additives such as a plasticize is thermally melted to a temperature at which the melt exhibits fluidity and subsequently, the melt containing the fluid cellulose acetate is cast.

Heat-melt molding methods are, in more detail, classified into a melt-extrusion molding method, a press molding method, an inflation method, an ejection molding method, a blow molding method, and a stretch molding method. Of these, in view of improving mechanical strength and surface accuracy, a melt extrusion method is preferable. A plurality of raw materials used in the melt extrusion method are preferably palletized usually by kneading in advance.

A well-known method is employed for the pelletizing. For example, dry cellulose acetate, a plasticizer, and other additives are supplied to an extruder with a feeder, kneaded by the use of a uniaxial or biaxial extruder, extruded in the shape of a strand from a die, cooled with water-cooling or air cooling and then cut into pellets.

Additives may be mixed before being supplied to an extruder, or may be supplied respectively by respective feeders.

A small amount of additives such as particles or an antioxidant may be preferably mixed in advance in order to mix it uniformly.

It is preferable to suppress the shearing power of an extruder and to process at a temperature capable of pelletizing as low as possible in order to avoid the deterioration of the resin (the decrease of a molecular weight, coloring, gel formation, etc.). For example, in the case of a biaxial extruder, it is preferable to rotate them in the same direction by the use of a deep groove type screw. In the viewpoint of the homogeneity in kneading, an engagement type is preferable.

The film formation is performed by use of the pellets obtained as above. Of course, it is also possible not to pelletize, but to supply the powder of a raw material as it is to an extruder with a feeder, and to carry out a film formation by using it.

The pellets prepared as above are melted at a melting temperature of from about 200 to about 300° C. using a single screw or twin screw type extruder. After foreign matter being removed via filtration employing a leaf disk type filter, the melting material is cast from a T die in the form of a film, solidified on a cooling roller, and cast while nipping the film employing a cooling roller and an elastic touch roller.

While fed into an extruder from a feeding hopper, it is preferable to minimize oxidation decomposition under vacuum or reduced pressure or under an ambience of inert gases.

It is preferable to stably control the extrusion flow rate by utilizing such as a gear pump. Further, as a filter utilized for elimination of foreign matters, a stainless fiber sintered filter is preferably utilized. A stainless fiber sintered filter is comprised of a stainless fiber assembly having been made into a complex coiled state and compressed to sinter the contacting points resulting in one body, and the filtering precision is adjustable by varying a density depending on the fiber diameter and the compression amount.

Additives such as a plasticizer and fine particles can be blended with the resin in advance or before the resin is fed to the extruder. A mixing means such as a static mixer is preferably used to mix the additives homogeneously with the resin.

At the time of nipping of film between the cooling roller and the elastic touch roller, the touch roller side film temperature is made preferably to Tg of the film or more and (Tg+110° C.) or less. As such a roller with an elastic surface to be used for the above object, well-known rollers may be employed.

An elastic touch roller is also referred to as a nipping pressure rotary member. As an elastic touch roller, those disclosed in, for example, Japanese Patent Nos. 3194904 and 3422798, and JP-A Nos. 2002-36332 and 2002-36333. As the touch roller, those commercially available may also be used.

When the film is peeled from the cooling roller, the tension is preferably controlled in order to prevent transformation of the film.

It is preferable that the film obtained as described above is stretched according to the aforementioned stretching operation, after passing through the process in which the film is in touch with the cooling roller.

As the method of stretching, a rolling machine or a tenter, well known in the art, may be preferably used. The stretching temperature is preferably the range of Tg to Tg+60° C., Tg representing the Tg of the resin usually used to constitute the film.

Before winding up the film, the edge portions are cut down by slitting to make the width of a product and a knurling process (an embossing process) may be applied on the both edges of the film to prevent adhesion or abrasion marks while winding. To provide knurling, a metal ring, on the side surface of which is provided with a roughness pattern, is heated and pressed onto the film. Herein, since the clipped portion at the both edge portions of the film is not usable as a product because of deformation of the film, it is cut out to be reused as a starting material.

### <Hard Coat Film>

The hard coat film of the present invention contains a cellulose acylate film containing a cellulose acetate having an acyl substitution degree of 2.0 or more but less than 2.5, and a hard coat layer. It is preferable that the hard coat layer contains an actinicray curable resin, and is a layer which contains, as a main component, a resin which is cured, via a crosslinking reaction, by being irradiated with actinic rays (also referred to as actinic energy rays) such as UV rays or electron beams.

As the actinic ray curable resin, a component which contains a monomer having an ethylenically unsaturated double bond is preferably employed, an actinic ray cured resin layer is formed by being hardened via irradiation of actinic rays such as UV rays or electron beams.

As an actinic ray curable resin, listed may be a UV ray curable resin and an electron beam curable rein, as typical examples, however, preferable is a resin which is curable via irradiation of UV rays is preferably used in view of the superior mechanical strength (namely, an anti-scratching property of a pencil hardness).

As a UV curable resin, for example, a UV-curable urethane acrylate type resin, a UV-curable polyester acrylate type resin, a UV-curable epoxy acrylate type resin, a UV-curable polyol acrylate type resin or a UV-curable epoxy type resin. may be preferably used. Of these, preferably used is a UV-curable acrylate type resin.

As a UV ray curable acrylate resin, a polyfunctional acrylate is preferably used. Examples of a polyfunctional acrylate include pentaerythritol polyfunctional acrylate, dipentaerythritol polyfunctional acrylate, pentaerythritol polyfunctional methacrylate and dipentaerythritol polyfunctional methacrylate. A polyfunctional acrylate as mentioned herein is a compound which is provided with at least two acryloyloxy groups or methacryloyloxy groups.

Preferable examples of a polyfunctional acrylate monomer include ethylene glycol diacrylate, diethyleneglycol diacrylate, 1,6-hexanediol diacrylate, neopentylglycol diacrylate, trimethylolpropane triacrylate, trimethylolethane triacrylate, tetramethylolmethane triacrylate, tetramethylolmethane tetraacrylate, pentaglycerol triacrylate, pentaerythritol diacrylate, pentaerythritol triacrylate, pentaerythritol tetraacrylate, glycerin triacrylate, dipentaerythritol triacrylate, dipentaerythritol tetraacrylate, dipentaerythritol pentaacrylate, dipentaerythritol hexaacrylate, tris(acryloyloxyethyl) isocyanurate, ethyleneglycol dimethacrylate, diethyleneglycol dimethacrylate, 1,6-hexanediol dimethacrylate, neopentylglycol dimethacrylate, trimethylolpropane trimethacrylate, trimethylolethane trimethacrylate, tetramethylolmethane trimethacrylate, tetramethylolmethane tetramethacrylate, pentaglycerol trimethacrylate, pentaerythritol dimethacrylate, pentaerythritol trimethacrylate, pentaerythritol tetramethacrylate, glycerin trimethacrylate, dipentaerythritol trimethacrylate, dipentaerythritol tetramethacrylate, dipentaerythritol pentamethacrylate, and dipentaerythritol hexamethacrylate. These compounds may be used alone or in combination of 2 kinds or more by mixing. They may also be an oligomer of a dimmer or a trimer of the above-mentioned monomer.

Regarding the viscosity of the polyfunctional acrylate, the viscosity at 25° C. is preferably 3000 mPa·s or less, more preferably 1500 mPa·s or less, and specifically preferably 1000 mPa·s or less As such a low viscosity resin, cited may be glycerin triacrylate, pentaerythritol triacrylate, and pentaerythritol tetraacrylate.

By using such a low viscosity resin, protrusion morphology may be easily formed on the hard coat layer, since sufficient fluidity can be obtained. The above mentioned viscosity is one measured at 25° C. using an E type viscosity meter.

It is preferable that the hard coat layer according to the present invention contains a monofunctional acrylate and a polyfunctional acrylate in the content ratio of polyfunctional acrylate:monofunctional acrylate=80:20 through 99:2, whereby the object of the present invention can be exhibited even under a more severe durability test condition.

Examples of a monofunctional acrylate include: isoboronyl acrylate, a 2-hydroxy-3-phenoxypropyl acrylate, isostealyl acrylate, benzyl acrylate, an ethyl carbitol acrylate, phenoxyethyl acrylate, lauryl acrylate, isooctyl acrylate, tetrahydro furfuryl acrylate, behenyl acrylate, 4-hydroxybutyl acrylate, 2-hydroxyethyl acrylate, 2-hydroxypropyl acrylate and a cyclohexyl 2-hydroxypropyl acrylate. Monofunctional acrylates are available from SHIN-NAKAMURA CHEMICAL Co., Ltd. or from OSAKA ORGANIC CHEMICAL INDUSTRY LTD.

It is preferable that a photopolymerization initiator is incorporated in the hard coat film in order to promote the hardening of the actinic ray curable resin. As the amount of the photopolymerization initiator, it is preferable that the photopolymerization initiator is contained in the ratio of photopolymerization initiator:actinic ray curable resin=20:100 to 0.01:100, in the mass ratio.

Specific examples of a photopolymerization initiator include such as acetophenone, benzophenone, hydroxy benzophenone, Michler's ketone, α-amyloxime ester and thioxanthone; and derivatives thereat however, the present invention is not limited thereto.

The hard coat layer according to the present invention preferably contains inorganic particles. Examples of such inorganic particles include silicon oxide, titanium oxide, aluminum oxide, tin oxide, indium oxide, ITO, zinc oxide, zirconium oxide, magnesium oxide, calcium carbonate, talc, clay, calcined kaolin, calcined calcium silicate, hydrated calcium silicate, aluminum silicate, magnesium silicate and calcium phosphate. Among these, silicon oxide, titanium oxide, aluminum oxide, zirconium oxide and magnesium oxide are specifically preferably used.

These inorganic particles are preferably coated with an organic component having a reactive functional group on a part of each surface of the inorganic particles, since such an organic component improves the abrasion resistance of the hard coat film while keeping the transparency. As a method to coat an organic component having a reactive functional group on a part of each surface of the inorganic particles, cited may be, for example, an embodiment in which a compound containing an organic component such as a slilane coupling agent is reacted with a hydroxyl group existing on the surface of a metal oxide particle, whereby the organic component is bound on a part of the surface of the metal oxide particle, an embodiment in which an organic component is adhered on a metal oxide particle via an interaction such as hydrogen bonding with a hydroxyl group existing on the surface of the metal oxide particle, or an embodiment in which one or two or more inorganic particles are incorporated in a polymer particle.

Also, organic particles may be used. Examples of such organic particles which may be added in the hard coat layer include: polymethacrylic acid methylacrylate resin powder, acryl-styrene resin powder, polymethyl methacrylate resin powder, silicon-containing resin powder, polystyrene resin powder, polycarbonate resin powder, benzoguanamine resin powder, melamine resin powder, polyolefin resin powder, polyester resin powder, polyamide resin powder, polyimide resin powder and polyfluorinated ethylene resin powder.

Specifically preferable particles include, for example, crosslinked polystyrene particles (such as SX-130H, SX-200H and SX-350H, produced by Soken Chemical & Engineering Co., Ltd.), polymethyl methacrylate particles (such as MX150 and MX300, produced by Soken Chemical & Engineering Co., Ltd.), and fluorine-containing acrylic resin particles. Examples of the fluorine-containing acrylic resin particles include: commercially available FS-701, produced by Nippon Paint Co., Ltd. and the like. Examples of acrylic particles include S-4000, produced by Nippon Paint Co., Ltd. Examples of acryl-styrene particles include S-1200, and MG-251, produced by Nippon Paint Co., Ltd.

The average particle diameter of these particles is not specifically limited, however, it is preferably from 0.01 to 5 μm and specifically preferably from 0.01 to 1.0 μm. It is also preferable that two or more kinds of particles having different particle diameters are contained. The average diameter of the particles may be measured using a laser diffraction particle diamerer distribution meter.

The ratio of the UV curable resin composition and the particles is preferably from 10 to 400 parts by mass of the particles, and more preferably from 50 to 200 parts by mass of the particles in 100 parts by mass of the resin composition.

The hard coat layer according to the present invention is preferably formed by applying a hard coat layer coating composition which has been diluted with a solvent which swells or partially dissolve a cellulose acylate film, followed by drying and curing, according to the following method, in view of the adhesiveness between the cellulose acylate film and the hard coat layer. A solvent containing ketone and/or an acetic acid ester is preferably used as the solvent which swells or partially dissolve a cellulose acylate film. With respect to the applied amount, the wet thickness of 0.1 to 40 μm is suitable, and it is preferably from 0.5 to 30 μm. The dry thickness is from 0.1 to 30 μm, preferably from 1 to 20 μm, and specifically preferably from 6 to 15 μm, as an average thickness.

The hard coat layer is formed by applying a hard coat layer coating composition to form a hard coat layer on a film substrate employing a coating method known in the art, for example, a gravure coater, a dip coater, a reverse coater, a wire bar coater, a die coater or an inkjet method, followed by drying and, then, UV curing, and, further, by heating after the UV cure, if necessary.

With respect to the drying, it is preferable to conduct a high temperature treatment at 70° C. or more of the decreasing rate drying zone temperature. The decreasing rate drying zone temperature is more preferably 80° C. or more, and specifically preferably 90° C. or more.

The light source for the UV cure treatment is not specifically limited as far as it can generate UV rays. Usable may be, for example, a low pressure mercury lamp, a medium pressure mercury lamp, a high pressure mercury lamp, a ultra-high pressure mercury lamp, a carbon arc lamp, a metal hydride lamp or a xenon lamp.

The irradiation condition varies depending on the type of the lamp. The amount of actinic ray irradiation is normally from 50 to 100 mJ/cm², and preferably from 50 to 300 mJ/cm².

It is preferable that the actinic ray irradiation step is conducted while imparting tension in the film conveying direction, and, more preferably, also in the width direction of the film. The tension to be imparted is preferably from 30 to 300 N/m. The method to impart tension is not specifically limited, and it may be conducted on a back roll in the film conveying direction, or in the width direction or in the biaxial directions using a tenter, whereby a film having further superior flatness can be obtained.

The hard coat layer may contain an electrically conductive material. As a preferable conductive material, metal oxide particles and π conjugated conductive polymer may be cited. An ionic liquid is also utilized as a conductive compound. Also, the hard coat layer may contain: an anion surfactant such as a silicone surfactant, fluorine-containing surfactant or polyoxyether; an anion surfactant; or a fluorine-siloxane graft polymer, in view of the coating property and uniform dispersibility of the particles. A fluorine-siloxane graft polymer, as mentioned herein, is a copolymerizing polymer obtained at least by grafting a polysiloxane containing siloxane monomer and/or an organosiloxane, and/or an organopolysiloxane to a fluorine-containing resin. As commercially available products, ZX-022H, ZX-007C, ZX-049 and ZX-047-D, produced by FUJI KASEI KOGYO KAISHA, Ltd., may be cited. It is preferable that these components are added in the range of 0.01 to 3% by mass, based on the mass of the solid content in the coating liquid.

The hard coat layer may be a single layer or a plurality of layers. The hard coat layer may be provide as two or more divided layer in order to easily control the hard coat performance, the haze or the arithmetic surface roughness Ra.

When two or more layers are provided, the thickness of the uppermost layer is preferably in the range of 0.05 to 2 μm. The lamination of two more layers may be conducted via a simultaneous lamination. The simultaneous lamination means to form two or more hard coat layers by a wet on wet process without providing a drying step to obtain a hard coat layer. In order to form a second hard coat layer wet on wet on a first hard coat layer without providing a drying process, sequential lamination may be conducted using extrusion waters, or simultaneous lamination may be conducted using a slot die having a plurality of slits.

With respect to the hard coat film of the present invention, the hardness condition is H or higher in pencil hardness as the index of hardness, more preferably 3H or higher. When the pencil hardness is 3H or higher, it is hard to be injured in a polarizing plate preparing step of a liquid crystal display device, further, high layer strength is exhibited when it is used for surface protecting film of a large screen liquid crystal display device or a liquid crystal display device for a digital signage frequently used in outdoor. The pencil hardness is determined using a film sample which is subjected to a humidity conditioning under a condition of 23° C. and a relative humidity of 55% for 2 hours, and measured according to the method defined by JIS-K-5400, using a pencil of which hardness is defined by JIS-S-6006.

The haze value of the hard coat film of the present invention is preferably 0.7% or less in view of the degree of clearness. The measurement of haze can be conducted according to JIS K-7136 by employing a haze meter (model NDH2000, produced by Nippon Denshoku Industries Co., Ltd.).

### <Functional Layers>

The hard coat film of the present invention may be provided with an antistatic layer, a back coat layer, an anti-reflection layer, a lubricant layer, an adhesive layer, an anti-glare layer, or a barrier layer.

### <Back Coat Layer>

On the hard coat film of the present invention, a back coat layer may be provided on the surface opposite to the surface on which a hard coat layer is formed, in order to prevent curl or sticking.

Examples of particles added in the back coat layer include, as examples of inorganic compounds, silicon dioxide, titanium dioxide, aluminum oxide, zirconium oxide, calcium carbonate, talc, clay, calcined kaolin, calcined calcium silicate, tin oxide, indium oxide, zinc oxide, ITO, hydrated calcium silicate, aluminum silicate, magnesium silicate and calcium phosphate.

The amount of the particles contained in the back coat layer is preferably from 0.1 to 50% by mass based on the mass of the binder. The increase in haze when a back coat layer is formed is preferably 1.5% or less, more preferably 0.5% or less, and still more preferably 0.1% or less.

As a binder, a cellulose acetate resin such as diacetyl cellulose is preferably used.

### <Antireflection Layer>

The hard coat film of the present invention may be used as an antireflection film having a function to prevent the reflection of outside light by applying an antireflection layer as an upper layer on the hard coat layer.

The antireflection layer is preferably laminated in consideration of such as a refractive index, a layer thickness, a number of layers and an order of layers so as to reduce reflectivity by optical interference. An antireflection layer is preferably constituted of a low refractive index layer having a lower refractive index than the refractive index of the substrate or a combination of a high refractive index layer having a higher refractive index than the refractive index of the substrate and a low refractive index layer. The antireflection layer is specifically preferably an antireflection layer constituted of not less than 3 refractive index layers and preferably contains 3 layers having different refractive indexes accumulated in the order of a medium refractive index layer (a layer having a refractive index higher than that of the hard coat layer or the substrate but lower than the refractive index of the high refractive index layer)/a high refractive index layer/a low refractive index layer, from the substrate side. Also, an antireflection layer having a layer construction of 4 layers or more in which 2 or more high refractive index layers and 2 or more low refractive index layers are alternately laminated.

Examples of a preferable layer constitution include the following constructions, however, the present invention is not limited thereto.

Cellulose acylate film/hard coat layer/low refractive index layer

Cellulose acylate film/hard coat layer/medium refractive index layer/low refractive index layer

Cellulose acylate film/hard coat layer/medium refractive index layer/high refractive index layer/low refractive index layer

Cellulose acylate film/hard coat layer/high refractive index layer (electrically conductive layer)/low refractive index layer

Cellulose acylate film/hard coat layer/anti-glare layer/low refractive index layer

The low refractive index layer which is essential in an antireflection layer preferably contains silica particles of which refractive index is lower than the refractive index of the cellulose acylate film which is the substrate, and is preferably in the range of 1.30 to 1.45 when measured at a wavelength of 550 nm and at 23° C.

The thickness of the low refractive index layer is preferably from 5 nm to 0.5 μm, more preferably from 10 nm to 0.3 μm, and most preferably from 30 nm to 0.2 μn.

With respect to the low refractive index layer forming composition, it is preferable that at least one kind of particles each have a shell layer and porous or vacant inside. Specifically, it is preferable that the particles each have a shell layer and porous or vacant inside are hollow silica particles.

It is also preferable that the low refractive index layer forming composition further contains an organo-silicon compound represented by following Formula (OSi-1), or hydrolyzed substance or polycondensation product thereof.

Si(OR)₄ Formula (OSi-1)

In the organo-silicon compound represented by the above formula, R represents an alkyl group having 1 to 4 carbon atoms. More concretely, for example, tetramethoxy silane, tetraethoxy silane, tetraisopropoxy silane are preferably used.

Further, a silane coupling agent, a hardener, or a surfactant may be added, if necessary.

### <Polarizing Plate>

The polarizing plate employing the hard coat film of the present invention will be described. The polarizing plate can be produced by a common method. It is preferable that rear side of the hard coat film of the present invention is subjected to alkali saponification treatment, treated the hard coat film is laminated on at least one side of a polarizer produced by immersing in iodine solution and stretching, using complete saponified type polyvinylalcohol aqueous solution.

On the other side, the hard coat film or another polarizing plate protecting film may be employed. It is preferable that a polarizing plate protecting film used on the other side opposite to the hard coat film of the present invention is a cellulose triacetate film or a film containing a thermoplastic acrylic resin and a cellulose acylate resin, in which the content ratio of the thermoplastic acrylic resin to the cellulose acylate resin is from 95:5 to 50:50. For example, cited may be a film disclosed in JP-A No. 2003-12859 having retardation values of Ro: from 0 to 5 nm and Rt: from −20 to 20 nm measured at 590 nm, namely, a non-orientation film, as one of the examples.

Alternatively, it is also possible to obtain a polarizing plate which enables expanding a viewing angle by employing an optical compensation film (also referred to as a retardation film) having retardation values of Ro: from 20 to 70 nm and Rt: from 70 to 400 nm measured at 590 nm. These films can be produced according to a method disclosed in JA-A No. 2002-71957. Further, it is preferable to use an optical compensation film having an optical anisotropic layer formed by orienting a liquid crystal compound such as a discotheque liquid crystal. The optical anisotropic layer can be formed by a method described in, for example, JP-A 2003-98348.

Examples of a preferably used commercially available polarizing plate protective film include KC8UX2MW, KC4UX, KC5UX, KC4UY, KC8UY, KC12UR, KC4UEW, KC8UCR-3, KC8UCR-4, KC8UCR-5, KC4FR-1, KC4FR-2, KC8UE and KC4UE (all produced by Konica Minolta Opto, Inc.)

A polarizer, which is a main component of the polarizing plate, is an element which transmits polarized light in only predetermined direction. A currently known representative polarizing film is a polyvinyl alcohol polarizer. Two types of polyvinyl alcohol polarizing films are known, namely, one is stained with iodine and the other is stained with a dichroic dye, but is not limited to these.

A polarizing film is prepared in such a manner that an aqueous polyvinyl alcohol solution is cast to form a film and then the film is monoaxially stretched, followed by dying, or the film is stained with a dye first and then monoaxially stretched, followed by carrying out a durability enhancing treatment employing a boron compound. The thickness of the polarizing is from 5 to 30 μm, and preferably from 8 to 15 μm.

The hard coat film of the present invention is adhered on the surface of the polarizer to form a polarizing plate. It is preferable to carry out the above adhesion employing an aqueous adhesive containing a completely saponified polyvinyl alcohol as the main component.

### <Adhesive Layer>

The adhesive layer which is provided on one surface of a protective film and used to be adhered with the substrate of a liquid crystal cell preferably exhibits a moderate viscoelasticity and adhesive property, and needless to say optical transparency.

Using adhesives, for example, an acrylic copolymer, an epoxy resin, a polyurethane, a silicone polymer, a polyether, a butyral resin, a polyamide resin, a polyvinyl alcohol resin or a synthetic rubber, the adhesive layer may be specifically cured via such as a drying method, a chemical curing method, a thermally curing method, a thermally melting method, or a photocuring method. Of these, an acrylic copolymer may be preferably used since its adhesive property is easiest to control, as well as it is excellent in transparency, environment resistance and durability.

### <Liquid Crystal Display Device>

By installing the polarizing plate of the present invention produced by employing a hard coat film of the present invention in a display device, varieties of image display devices excellent in visibility can be produced.

By being installed in a polarizing plate, the hard coat film of the present invention can be preferably used in liquid crystal display devices of such as reflective type, transmission type, half-transmission type, or of various modes such as TN mode, STN mode, OCB mode, HAN mode, VA mode (including PVA mode and MVA mode), IPS mode and OCB mode.

### EXAMPLES

The present invention will be concretely explained with referring to examples, however, the present invention is not limited thereto.

### Example 1

First, the method to prepare the elastic particles used in the examples will be explained.

### (Method of Preparing Elastic Particles A)

In a 10 liter polymerization container equipped with a reflux condenser, 1500 parts by mass of deionized water and 75 parts by mass of 10% aqueous solution of EMULGEN 950 (produced by Kao Corp.) were charged, and heated to 70° C. while stirring under a nitrogen gas flow. Then, 75 parts by mass of ethylacrylate was added and dispersed for 10 minutes, and, thereafter, 6 parts by mass of 10% aqueous solution of 2,2′-azobis(2-amidinopropane) dihydrochloride (V-50, produced by Wako Pure Chemical Industries, Ltd.) was added, followed by stirring for one hour to prepare a seed latex.

The obtained seed latex was heated to 75° C. and added with 1.38 parts by mass of 2,2′-azobis (2-(2-imidazoline-2-yl)propane (VA-061, produced by Wako Pure Chemical Industries, Ltd.), and, further, the following monomer emulsion liquid of core formation was continuously fed spending 200 minutes to carry out seed polymerization.

### (Monomer Emulsion Liquid of Core Formation)

| | | |
|---|---|---|
| 2-ethylhexyl acrylate | 923 | parts by mass |
| Butyl acrylate | 247 | parts by mass |
| Acryl methacrylate | 2.5 | parts by mass |
| 1,4-butylene glycol diacrylate | 2.5 | parts by mass |
| 10% aqueous solution of EMULGEN 950 | 750 | parts buy mass |
| (produced by Kao Corp.) | | |
| Deionized water | 3750 | parts by mass |

After feeding the monomer emulsion liquid, the temperature was raised to 90° C. and was ripened for one hour to form the core. The mass average particle diameter of the core was 0.10 μm.

The product was cooled to 70° C., 1.25 parts by mass of 2,2′-azobis (2-(2-imidazoline-2-yl)propane (VA-061, produced by Wako Pure Chemical Industries, Ltd.) was added, and, then, the following monomer emulsion liquid was continuously fed spending 40 minutes to carry out seed polymerization for the shell formation.

| | | |
|---|---|---|
| Methyl methacrylate | 805 | parts by mass |
| Ethyl acrylate | 95 | parts by mass |
| Styrene | 48 | parts by mass |
| Metaacryl amide | 6.3 | parts by mass |
| Diethylene glycol dimethacrylate | 476 | parts by mass |
| 10% aqueous solution of EMULGEN 985 | 190 | parts by mass |
| (produced by Kao Corp.) | | |
| Demineralized water | 381 | parts by mass |

After feeding the monomer emulsion liquid, the temperature was raised to 75° C. and was ripened for one hour to form the shell.

The product was cooled, filtered, freezed at −30° C., dehydrated and washed using a centrifugal machine, and dried by blowing to obtain Elastic particles A having a core-shell structure.

The mass average particle diameter of the particles was determined by diluting the particles using ethanol by 50 times and by using a dynamic light scattering type particle diameter measuring apparatus ZETASIZER 1000HS (produced by Malvern Instruments Ltd).

### (Method of Preparing Elastic Particles B)

Elastic particles B were prepared in the same manner as the preparation of Elastic particles A except that the ripening period of the monomer emulsion liquid for core formation of Elastic particles A was changed to 10 minutes, the amount of emulsion liquid, parts by mass, used for the seed polymerization for shell formation was reduced to ½, and the duration of continuous feeding was changed to 10 minutes.

### (Method of Preparing Elastic Particles C)

Elastic particles C were prepared in the same mariner as the preparation of Elastic particles A except that the amount of emulsion liquid, parts by mass, used for the seed polymerization for shell formation was reduced to ⅔, and the duration of continuous feeding was changed to 27 minutes.

### (Method of Preparing Elastic Particles D)

Elastic particles D were prepared in the same manner as the preparation of Elastic particles A except that, in the monomer emulsion liquid for core formation, the “923 parts by mass” of 2-ethylhexyl acrylate was changed to “210 parts by mass”, and the “247 parts by mass” of butylacrylate was changed to “985 parts by mass”.

### (Method of Preparing Elastic Particles E)

Elastic particles E were prepared in the same manner as the preparation of Elastic particles D except that, after the monomer emulsion feeding, the temperature was raised to 80° C., and the ripening duration was changed to 90 minutes.

### (Method of Preparing Elastic Particles F)

Elastic particles F were prepared in the same manner as the preparation of Elastic particles D except that t, after the monomer emulsion feeding, the temperature was raised to 85° C., and the ripening duration was changed to 120 minutes.

### (Comparative Particles G)

Further, commercially available silica particles (R972V, produced by Nippon Aerosil Co., Ltd.) were used for comparison.

### (Comparative Particles H)

Further, commercially available silica particles (SEAHOSTAR KE-P10, produced by Nippon Shokubai Co., Ltd) were used for comparison.

### (Comparative Particles I)

Further, commercially available silica particles (SEAHOSTAR KE-P30, produced by Nippon Shokubai Co., Ltd) were used for comparison.

The mass average particle diameter, compressive deformation rate and refractive index of each particle were listed in Table 1.

TABLE 1

| | Average particle | Compressive | Refractive |
|---|---|---|---|
| Particles | diameter (μm) | deformation rate | index |
| Elastic particles A | 0.5 | 1.1 | 1.48 |
| Elastic particles B | 0.01 | 1.0 | 1.49 |
| Elastic particles C | 0.1 | 1.2 | 1.48 |
| Elastic particles D | 1.0 | 1.3 | 1.48 |
| Elastic particles E | 2.0 | 1.5 | 1.48 |
| Elastic particles F | 2.5 | 1.7 | 1.48 |

| | | |
|---|---|---|
| Silica particles G | 0.01 | R972V (produced by Nippon |
| | | Aerosil Co., Ltd.) |
| Silica particles H | 0.1 | SEAHOSTAR KE-P10 (produced |
| | | by Nippon Shokubai Co., Ltd) |
| Silica particles I | 0.3 | SEAHOSTAR KE-P30 (produced |
| | | by Nippon Shokubai Co., Ltd) |

### [Preparation of Hard Coat Film 1]

### <Preparation of Cellulose Acylate Film 1>

In a solution tank in which methylene chloride was charged, diacetyl cellulose (having an acy substitution degree of 2.0) was added, and heated to dissolve completely, followed by filtering by using Azumi filter paper No. 244 manufactured by Azumi Filter Paper Co., Ltd.

A main dope liquid of the following composition was prepared. First, methylene chloride and ethanol were added to a pressure solution tank. The above cellulose ester was supplied into the pressure solution tank storing the solvent while being agitated. Further, it was dissolved completely while being heated and agitated. The resultant liquid was filtered by use of Azumi filter paper No. 244 manufactured by Azumi Filter Paper Co., Ltd., whereby a main dope liquid was prepared.

### <Composition of Main Dope>

| | | |
|---|---|---|
| Methylene chloride | 380 | parts by mass |
| Ethanol | 70 | parts by mass |
| Diacetyl cellulose (having acetyl substitution | 100 | parts by mass |
| degree of 2.0) | | |
| 10% Elastic particles A dispersion in acetone | 5 | parts by mass |
| Additive A | 8 | parts by mass |

The dope prepared as mentioned above was cast on a support containing an endless belt made of stainless steel at 30° C. through a casting die warmed at 30° C. at a width of 1.6 m to form a web, followed by being dried on the support, and the web was peeled off from the support by a peeling off roll after having been dried on a support until the residual solvent amount of the web decreased to 80% by mass.

Next, the web was dried in a transfer drying process by means of plural number rolls arranged up and down, by a drying wind of 70° C., and successively, after the both edges of the web were held with a tenter was stretched in the width direction at 150° C. to make the width of 130% of that before stretching. After stretching with a tenter, the web was dried by a drying wind of 105° C. in a transfer drying process by means of plural number of rolls arranged up until the residual solvent decreased to 0.3% by mass, where by Cellulose acylate film 1 was obtained. Further, the prepared Cellulose acylate film 1 was heat treated at a treatment temperature of 105° C. for 15 minutes. The stretching ratio of the web in the web conveyance direction just after peeled was calculated to be 110% from the rotation rate of the stainless band support and the driving rate of the tenter.

Further, following Back coat layer coating composition 1 was prepared by filtering employing a filter exhibiting a capture ratio of 3 μm particles of 99% or more. This Back coat layer coating composition 1 was applied onto the side of Cellulose acylate film 1 opposite to the side which was in contact with the stainless steel band substrate employing an extrusion coater, to obtain a 15 μm wet thickness via an online system, and was dried at 90° C. for 30 seconds. The product was cooled to room temperature, trimmed at the edge portions, and wound on a core, whereby a long length Cellulose acylate film 1 having a thickness of 80 μm, a length of 3000 m, a width of 1.8 m and a refractive index of 1.49 was obtained.

### <Back Coat Layer Coating Composition 1>

| | |
|---|---|
| Diacetyl cellulose (acetyl substitution degree of 2.4) | 0.5 part by mass |
| Acetone | 70 parts by mass |
| Methanol | 20 parts by mass |
| Propylene glycol monomethyl ether | 10 parts by mass |
| 2% Elastic particle dispersion A in acetone | 0.2 part by mass |

### <Preparation of the Hard Court Film 1>

On Cellulose acylate film 1 prepared as described above, the following UV curable resin composition 1 which had been filtered through a filter made of polypropylene having a pore size of 0.4 μm was coated by use of a gravure coater on the side of Cellulose acylate film 1 opposite to the side on which the back coat layer had been provided. After drying the obtained film at a constant rate drying zone temperature of 95° C. and decreasing rate drying zone temperature of 95° C., the applied layer was cured using a UV lamp at a lighting intensity on an irradiation portion of 100 mW/cm² and an irradiance quantity of 0.3 J/cm², while being purged with nitrogen so as to form an atmosphere having oxygen content of 1.0% by volume or less to form a hard coat layer of which dry thickness was 7 μm, followed by being wound, whereby Hard coat film 1 of a roll shape was prepared.

### <Preparation of Fluorine-Siloxane Graft Polymer)

The commercial names of the materials used for the preparation of fluorine-siloxane graft polymer will be shown.

Radically polymerizable fluorine-containing resin (A): CEFRALCOAT CF-803 (hydroxyl group value of 60, number average molecular weight of 15,000; manufactured by Central Glass Co., Ltd.),

One end radical polymerizing polysiloxane (B): SILAPLANE FM-0721 (number average molecular weight of 5,000; manufactured by Chisso Corp.),

Radical polymerization initiator: PERBUTYL O (t-butylperoxy-2-ethylhexanoate; manufactured by NOF Corp.), and

Hardener: SUMDULE N3200 (burette type prepolymer of hexamethylene diisocyanate; manufactured by Sumitomo Bayer Urethane Co., Ltd.

### (Synthesis of Radically Polymerizable Fluorine-Containing Resin)

CEFRALCOAT CF-803 (1554 parts by mass), xylene (233 parts by mass) and 2-isocyanate ethylmethacrylate (6.3 weight parts) were charged in a glass reaction vessel equipped with a mechanical stirrer, a thermometer, a condenser and a dry nitrogen gas introducing inlet, and the system was heated at 80° C. under a dry nitrogen atmosphere. Reaction proceeded at 80° C. for 2 hours, and the reaction mixture was taken out after confirming by infrared spectrogram of a sampled product that isocyanate had been disappeared, whereby 50 weight % via urethane bonding of radically polymerizable fluorine-containing resin was prepared.

Above-synthesized radically polymerizable fluorine-containing resin (26.1 parts by mass), xylene (19.5 parts by mass), n-butyl acetate (16.3 parts by mass), methyl methacrylate (2.4 parts by mass), n-butyl methacrylate (1.8 parts by mass), lauryl methacrylate (1.8 parts by mass), 2-hydroxyethyl methacrylate (1.8 parts by mass), FM-0721 (5.2 parts by mass) and PERBUTYL 0 (0.1 part by mass) were charged in a glass reaction vessel equipped with a mechanical stirrer, a thermometer, a condenser and a dry nitrogen gas introducing inlet, and the system was kept at 90° C. for 2 hours after having been heated up to 90° C. under a nitrogen atmosphere. PERBUTYL 0 (0.1 part) was further added and the system was kept at 90° C. for 5 hours, whereby a 35 mass % solution of fluorine-siloxane graft polymer having a weight average molecular weight of 171,000 was prepared. The weight average molecular weight of the fluorine-siloxane graft polymer was determined by HPLC (liquid chromatography).

### <UV Curable Resin Composition 1>

| | |
|---|---|
| Pentaerythritol tri/tetraacrylate (NK esterA- | 100 parts by mass |
| TMM-3L, manufactured by Shin-Nakamura | |
| Chemical Co., Ltd.) | |
| IRGACURE 184 (manufactured by BASF Japan | 5 parts by mass |
| Ltd.) | |
| Fluorine-siloxane graft polymer (35% by mass) | 2 parts by mass |
| Propylene glycol monomethylether | 10 parts by mass |
| Methyl acetate | 50 parts by mass |
| Methyl ethyl ketone | 50 parts by mass |

### [Preparation of Hard Coat Films 2 to 27]

Hard coat films 2 to 27 were prepared in the same manner as the preparation of Hard coat film 1, except that Cellulose acylate films 2 to 27 were prepared by changing Cellulose acylate film 1 used for Hard coat film 1 to have cellulose acetate films having the acyl substitution degrees given in Table 3, elastic particles, and kinds and amounts of additives listed in Table 3, followed by applying UV curable resin composition 1 on each surface.

The kinds of additives used for the cellulose acylate films were listed in Table 2, and the constitutions of cellulose acylate films and hard coat films were listed in Table 3.

TABLE 2

| Additive | Kind | |
|---|---|---|
| A | Polyester | Compound shown below |
| B | Polyester | Compound shown in [Example 1] of |
| | | WO 2004/067639 |
| C | Sugar ester compound | MONOPET SB (Dai-ichi Kogyo |
| | | Seiyaku Co., Ltd.) |
| D | Phosphoric acid ester | Triphenyl phosphate |

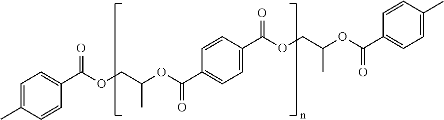

TABLE 3

| | | Cellulose | | | | | | | Widened | |
|---|---|---|---|---|---|---|---|---|---|---|
| | | acetate | Particles | | Additive | | Stretching | | substrate | |
| Hard | Cellulose | Acyl | | Average | | Adding | ratio | Maximum | film (High | |
| coat | acylate | substi- | | particle | | amount | in TD | value | stretching | |
| film | film | tution | | diameter | | (% by | direction | of tan | ratio | |
| No. | No. | degree | Kind | (μm) | Kind | mass) | (%) | δ | aptitude) | Remarks |
| 1 | 1 | 2.0 | Elastic particles A | 0.5 | A | 8 | 130 | 1.95 | B | Inventive |
| 2 | 2 | 2.2 | Elastic particles A | 0.5 | A | 8 | 130 | 1.40 | A | Inventive |
| 3 | 3 | 2.3 | Elastic particles A | 0.5 | A | 8 | 130 | 1.20 | A | Inventive |
| 4 | 4 | 2.45 | Elastic particles A | 0.5 | A | 8 | 130 | 0.90 | A | Inventive |
| 5 | 5 | 2.2 | Elastic particles B | 0.01 | A | 8 | 130 | 0.80 | B | Inventive |
| 6 | 6 | 2.2 | Elastic particles C | 0.1 | A | 8 | 130 | 0.90 | A | Inventive |
| 7 | 7 | 2.2 | Elastic particles D | 1.0 | A | 8 | 130 | 2.00 | B | Inventive |
| 8 | 8 | 2.2 | Elastic particles A | 0.5 | A | 10 | 130 | 1.45 | A | Inventive |
| 9 | 9 | 2.2 | Elastic particles A | 0.5 | B | 8 | 130 | 1.25 | A | Inventive |
| 10 | 10 | 2.2 | Elastic particles A | 0.5 | A/C | 4/4 | 130 | 1.30 | A | Inventive |
| 11 | 11 | 2.2 | Elastic particles A | 0.5 | D | 8 | 130 | 0.80 | B | Inventive |
| 12 | 12 | 2.2 | Elastic particles A | 0.5 | C | 8 | 110 | 1.30 | A | Inventive |
| 13 | 13 | 2.2 | Elastic particles A | 0.5 | C | 8 | 130 | 1.30 | A | Inventive |
| 14 | 14 | 2.2 | Elastic particles A | 0.5 | C | 8 | 150 | 1.30 | A | Inventive |
| 15 | 15 | 2.6 | Elastic particles A | 0.5 | A | 8 | 130 | 0.85 | *1 | Comparative |
| 16 | 16 | 2.7 | Elastic particles A | 0.5 | A | 8 | 130 | 0.83 | *1 | Comparative |
| 17 | 17 | 2.9 | Elastic particles A | 0.5 | A | 8 | 130 | 0.80 | *1 | Comparative |
| 18 | 18 | 2.45 | Elastic particles E | 2.0 | A | 8 | 130 | 2.30 | *1 | Comparative |
| 19 | 19 | 2.45 | Elastic particles F | 2.5 | A | 8 | 130 | 2.50 | *1 | Comparative |
| 20 | 20 | 2.2 | none | — | A | 8 | 130 | 0.75 | *1 | Comparative |
| 21 | 21 | 2.4 | none | — | A | 8 | 130 | 0.72 | *1 | Comparative |
| 22 | 22 | 2.45 | none | — | A | 8 | 130 | 0.70 | *1 | Comparative |
| 23 | 23 | 2.7 | none | — | A | 8 | 130 | 0.68 | *l | Comparative |
| 24 | 24 | 2.2 | Silica particles G | 0.01 | A | 8 | 130 | 0.75 | *1 | Comparative |
| 25 | 25 | 2.2 | Silica particles H | 0.1 | A | 8 | 130 | 0.75 | *1 | Comparative |
| 26 | 26 | 2.2 | Silica particles I | 0.3 | A | 8 | 130 | 0.75 | *1 | Comparative |
| 27 | 27 | 2.2 | Elastic particles A | 0.5 | none | — | 130 | 0.65 | *1 | Comparative |

*1: C (rupture occurs often, becomes brittle)

### <<Evaluation 1>>

(tan δ)

The dynamic viscoelasticity of each of Cellulose acylate films 1 to 27 prepared as described above was measured under the following condition, and the maximum value of tan δ was obtained. The samples were subjected to moisture control at 23° C. under 55% RH for 24 hours, and each measurement was carried out under 55% RH while elevating temperature under the following condition.

| | |
|---|---|
| Measuring apparatus: | RSA III (produced by TA Instruments) |
| Sample: | 5 mm in width, 50 mm in length |
| | (gap was set at 20 mm) |
| Measuring condition: | Stretching mode |
| Measuring temperature: | From 20 to 200° C. |
| Elevating temperature condition: | 5° C./min |
| Frequency: | 1 Hz |
| Measuring direction: | Longitudinal direction of the film |

### (Wide Film Aptitude)

Evaluation was conducted according to the following criteria by examining whether the cellulose acylate film could be stretched by 40% at 150° C., and whether break up or cracks occurred when the cellulose acylate film was doubled over.
A: Rupture of the film was negligible and no break up nor cracks occurred when the film was doubled over.
B: Rupture of the film was negligible, however, break up or cracks occasionally occurred when the film was doubled over.
C: Rupture of the film often occurred, and break up or cracks occurred when the film was doubled over.
D: The film could not be stretched due to rupture of the film.

### <Haze>

### <Three Sheets Value>

Three hard coat film samples were stacked, and subjected to haze measurement employing T-2600DA produced by Tokyo Denshoku Kogyo Co., Ltd. according to the method of ASTM-D1003-52.

### <Pencil Hardness>

Measurement was carried out according to the method of HS K5401. Onto a 4H pencil held at an angle of 45 degree, a load of 500 g was applied and scraping test was conducted on the surface of each hard coat film. Three sets of tests were conducted where each set contains 5 scraping tests, and the resulting scratch mark formed in each set was evaluated.

A: Extremely high hardness was observed, and the hardness was uniform.

B: Sufficiently high hardness was observed, and the hardness was uniform.

C: High hardness was observed, but the hardness was not uniform

D: Only low hardness was observed and the hardness was not uniform.

### (Exfoliation and Cracks)

Exfoliation and cracks were evaluated according to the following observation by cutting each hard coat film.

A: No exfoliation of the hard coat film and the substrate was observed, and no cracks were observed at the cut surface.

B: Slight exfoliation of the hard coat film and the substrate was observed, but no cracks were observed at the cut surface.

C: A portion in which exfoliation of the hard coat film and the substrate occurred was observed, or cracks were observed at the cut surface.

TABLE 4

| | Cellulose | Hard coat film | | | |
|---|---|---|---|---|---|
| Hard coat | acylate | | Pencil | Exfoliation, | |
| film No. | film No. | Haze | hardness | cracks | Remarks |
| 1 | 1 | 0.40 | B | B | Inventive |
| 2 | 2 | 0.40 | A | A | Inventive |
| 3 | 3 | 0.40 | A | A | Inventive |
| 4 | 4 | 0.45 | A | A | Inventive |
| 5 | 5 | 0.45 | B | B | Inventive |
| 6 | 6 | 0.55 | A | A | Inventive |
| 7 | 7 | 0.50 | B | B | Inventive |
| 8 | 8 | 0.35 | A | A | Inventive |
| 9 | 9 | 0.45 | A | A | Inventive |
| 10 | 10 | 0.35 | A | A | Inventive |
| 11 | 11 | 0.40 | B | B | Inventive |
| 12 | 12 | 0.40 | A | A | Inventive |
| 13 | 13 | 0.40 | A | A | Inventive |
| 14 | 14 | 0.40 | A | A | Inventive |
| 15 | 15 | 0.70 | C (hard but | C | Comparative |
| | | | not uniform) | | |
| 16 | 16 | 0.80 | C (hard but | C | Comparative |
| | | | not uniform) | | |
| 17 | 17 | 0.90 | C (hard but | C | Comparative |
| | | | not uniform) | | |
| 18 | 18 | 0.90 | C (hard but | C | Comparative |
| | | | not uniform) | | |
| 19 | 19 | 1.30 | C (hard but | C | Comparative |
| | | | not uniform) | | |
| 20 | 20 | 1.10 | C (hard but | C | Comparative |
| | | | not uniform) | | |
| 21 | 21 | 1.00 | C (hard but | C | Comparative |
| | | | not uniform) | | |
| 22 | 22 | 1.00 | C (hard but | C | Comparative |
| | | | not uniform) | | |
| 23 | 23 | 0.90 | C (hard but | C | Comparative |
| | | | not uniform) | | |
| 24 | 24 | 1.10 | C (hard but | C | Comparative |
| | | | not uniform) | | |
| 25 | 25 | 1.05 | C (hard but | C | Comparative |
| | | | not uniform) | | |
| 26 | 26 | 1.00 | C (hard but | C | Comparative |
| | | | not uniform) | | |
| 27 | 27 | 1.00 | C (hard but | C | Comparative |
| | | | not uniform) | | |

It is clear from Tables 3 and 4 that the cellulose acylate film and the hard coat film of the present invention exhibit superior “wide film aptitude when stretched”, “haze”, “pencil hardness”, “exfoliation and cracks of hard coat film” when compared with those of comparative examples.

### Example 2

### Production of Polarizing Plate

### <Production of Polarizer>

A polyvinyl alcohol film having a thickness of 120 μm was immersed in 100 parts by mass of aqueous solution containing 1 part by mass of iodine and 4 parts by mass of boric acid, and was stretched by 4 times at 50° C. to obtain a polarizer having a width of 1.4 m, of which thickness was 25 μm.

A saponification treatment was conducted under the alkali-saponification condition described below on each of prepared Hard coat film samples 1 to 27 and Konica Minolta TAC KC4UE (produced by Konica Minolta Opto, Inc., thickness: 80 μm) which is a commercially available polarizing plate protective film.

Subsequently, using the above prepared polarizer, the above prepared hard coat film, polarizer, KC4UE were laminated in that order using a 5% aqueous solution of fully saponified polyvinyl alcohol, whereby Polarizing plates 1 to 27 were prepared.

### <Alkali-Saponification Treatment>

| | | |
|---|---|---|
| Saponification process | 2N—NaOH | at 50° C. for 90 seconds |
| Washing process | Water | at 30° C. for 45 seconds |
| Neutralization process | 10% by mass of HCl | at 30° C. for 45 seconds |
| Washing process | Water | at 30° C. for 45 seconds |

Under the above condition, each film sample was treated in the order of saponification, washing, neutralization, washing, followed by drying at 80° C.

### <<Evaluation 2>>

### (Polarizing Plate Processing Aptitude)

Existence or non-existence of defects due to foreign substance when the polarizer and the retardation film sample were adhered in the polarizing plate preparation process was visually observed.

A: No defects due to foreign substance formed in the adhering process were observed, and a high production yield was obtained.

B: Slight existence of defects due to foreign substance formed in the adhering process was observed, however, the production yield was practically acceptable.

C: Defects due to foreign substance formed in the adhering process were observed, and, the production yield was low.

### (Liquid Crystal Display Panel Fabrication Aptitude)

The polarizing plate of 32-sized liquid crystal television KDL-32V2000 produced by SONY Corp. were removed, and each of the inventive polarizing plates and comparative polarizing plates prepared as above was adhered on the liquid crystal display so that the absorption axis of the polarizing plate lies in the same direction as the absorption axis of the originally installed polarizing plate. In this manner, liquid crystal display devices 1 to 27 were fabricated, and existence or non-existence of exfoliation of the hard coat film and cracks were evaluated.

A: No cracks and defects due to foreign substance formed in the fabrication process were observed, and an excellent production yield was obtained.

B: Slight cracks and defects due to foreign substance formed in the fabrication process were observed, however, the production yield was practically acceptable.

C: Cracks and defects due to foreign substance formed in the fabrication process were observed, and the production yield was low.

TABLE 5

| Liquid | | Polarizing | | |
|---|---|---|---|---|
| crystal | Polarizing | plate | Liquid crystal | |
| display panel | plate | processing | display panel | |
| No. | No. | aptitude | fabrication aptitude | Remarks |
| 1 | 1 | B | B | Inventive |
| 2 | 2 | A | A | Inventive |
| 3 | 3 | A | A | Inventive |
| 4 | 4 | A | A | Inventive |
| 5 | 5 | B | B | Inventive |
| 6 | 6 | A | A | Inventive |
| 7 | 7 | B | B | Inventive |
| 8 | 8 | A | A | Inventive |
| 9 | 9 | A | A | Inventive |
| 10 | 10 | A | A | Inventive |
| 11 | 11 | B | B | Inventive |
| 12 | 12 | A | A | Inventive |
| 13 | 13 | A | A | Inventive |
| 14 | 14 | A | A | Inventive |
| 15 | 15 | C | C | Comparative |
| 16 | 16 | C | C | Comparative |
| 17 | 17 | C | C | Comparative |
| 18 | 18 | C | C | Comparative |
| 19 | 19 | C | C | Comparative |
| 20 | 20 | C | C | Comparative |
| 21 | 21 | C | C | Comparative |
| 22 | 22 | C | C | Comparative |
| 23 | 23 | C | C | Comparative |
| 24 | 24 | C | C | Comparative |
| 25 | 25 | C | C | Comparative |
| 26 | 26 | C | C | Comparative |
| 27 | 27 | C | C | Comparative |

It is clear that the polarizing plate and the liquid crystal display panel of the present invention exhibit superior polarizing plate fabrication aptitude and liquid crystal display panel fabrication aptitude when compared with those of the comparative examples.

1. A hard coat film comprising:
a cellulose acylate film having laminated thereon a hard coat layer,
wherein:
the cellulose acylate film comprises a cellulose acetate having an acyl substitution degree of 2.0 or more but less than 2.5, and elastic particles, and
a maximum value of tan δ at temperatures of 20° C. to 200° C. is 0.08 or more but 2.00 or less, tan δ being a value of a loss modulus/a storage modulus.

2. The hard coat film of claim 1, wherein the elastic particles are crosslinked acrylic resin particles having an average particle diameter of 0.01 μm to 1.0 μm.

3. The hard coat film of claim 1, wherein:
the cellulose acylate film comprises at least a sugar ester compound or an ester compound having a structure represented by Formula (I),
P1-(G2-T1)n-G3-P2 (I)
where P1 and P2 each independently represent a moriocarboxylic acid residue, G2 and G3 each independently represent a glycol residue having two or more carbon atoms, T1 represents a carboxylic acid residue, and n represents an integer of 1 or more,
wherein G2 and T1 each may contain a plurality of residues.

4. A polarizing plate comprising a polarizer adhered with a hard coat film of claim 1 on at least one surface of the polarizer.

5. A liquid crystal display device employing the polarizing plate of claim 4.
